(19) United States
(12) Patent Application Publication
(10) Pub. No.: US 2007/0054042 A1
(43) Pub. Date: Mar. 8, 2007

(54) Method of SrCu2O2 spin-on precursor synthesis and low temperature p-type thin film deposition

(75) Inventors: Wei-Wei Zhuang, Vancouver, WA (US); Yoshi Ono, Camas, WA (US); Wei Gao, Vancouver, WA (US)

Correspondence Address: ROBERT D. VARITZ, 4915 S.E. 33RD PLACE, PORTLAND, OR, 97202, US

(73) Assignee: Sharp Laboratories of America, Inc.

(21) Appl. No.: 11/220,885

(22) Filed: Sep. 6, 2005

(51) Int. Cl. B05D 3/12; B05D 3/02

(52) U.S. Cl. 427/240; 427/372.2

(57) ABSTRACT

A method of SrCu₂O₂ spin-on precursor synthesis and low temperature p-type thin film deposition, includes preparing a wafer to receive a spin-coating thereon; selecting metalorganic compounds to form a SrCu₂O₂ precursor, mixing and refluxing the metalorganic compounds to form a precursor mixture; filtering the precursor mixture to produce a spin-coating precursor; applying the spin-coating precursor to the wafer in a two-step spin coating procedure; baking the spin-coated wafer using a hot-plate bake to evaporate substantially all of the solvents; and annealing the spin-coated wafer to form a SrCu₂O₂ layer thereon in a two-step post-anneal process.

### FIELD OF THE INVENTION

This invention relates to the synthesis of a SrCu₂O₂ (SCO) spin-on precursor solution and the deposition of corresponding thin films, which have p-type conductivity and which may be used with ZnO thin films for fabricating light emitting devices.

### BACKGROUND OF THE INVENTION

ZnO is an excellent material, with n-type characteristics, for generating a pn junction, which, when used in a light emitting diode, generates near UV light, at about 380 nm, corresponding to its bandgap. A p-type material is required to complete the pn structure. Cu(I) based oxides, such as SrCu₂O₂, AlCuO₂ and GaCuO₂ are used as p-type materials to complete the pn junction in known devices.

In 2002, Ohta et al., Fabrication and Current Injection UV-light Emission from a transparent p-n Heterojunction Composed of p-SrCu₂O₂ and n-ZnO, Key Engineering Materials, Vol. 214-215 pp. 75-80 (2002), reported the fabrication of pn heterojunctions of p-SrCu₂O₂ and n-ZnO using pulsed laser ablation deposition techniques. The integration of these films includes single crystal yittria-stabilized zirconia ZrO₂ (YSZ) as the substrate, indium-tin-oxide (ITO) as a transparent n-type electrode, and a combination of n-type ZnO and p-type SrCu₂O₂, and a thin nickel film, as the top electrode. Electroluminescence was observed to emanate from this structure. Also in 2002, Martinson, Synthesis of Single Phase SrCu₂O₂ from liquid precursors, Journal of Young Investigators, Vol. 10, Issue 3, March 2004, reported the synthesis of single phase SrCu₂O₂ from water based liquid precursors using a spray technique, however, there was no mention of the integration of n-type ZnO and p-SrCu₂O₂.

There are no known reports describing the synthesis of a stable organic solvent based SrCu₂O₂ spin-on precursors. Water based precursor solutions are used for spray deposition, which result in films having micrometer thicknesses. It is difficult to achieve uniform films having a thickness of about 100 nm. For the deposition of high quality thin films, spin-coating techniques, using organic solvent based precursors provide a simple and convenient protocol.

### SUMMARY OF THE INVENTION

A method of SrCu₂O₂ spin-on precursor synthesis and low temperature p-type thin film deposition, includes preparing a wafer to receive a spin-coating thereon; selecting metalorganic compounds to form a SrCu₂O₂ precursor, including selecting strontium acetate (Sr(OAc)₂) and copper(II) acetate monohydrate (Cu(OAc)₂.H₂O), and acetic acid (HOAc) as a solvent, to form a precursor mixture; mixing and refluxing the selected metalorganic compounds to form a precursor mixture; adding ethanolamine to the precursor mixture; filtering the precursor mixture to produce a spin-coating precursor; applying the spin-coating precursor to the wafer in a two-step spin coating procedure, including: spin coating the wafer at a first, slow spin speed; and spreading the spin-coating precursor on the wafer at a second, higher spin speed; baking the spin-coated wafer using a hot-plate bake to evaporate substantially all of the solvents; and annealing the spin-coated wafer to form a SrCu₂O₂ layer thereon in a two-step post-anneal process to obtain a Cu(I)₂O phase, wherein a first annealing step includes annealing the spin-coated wafer in forming gas in a temperature range of between about 300° C. to 700° C. for about five minutes; and wherein a second annealing step includes annealing in a controlled oxygen/nitrogen atmosphere, having an oxygen percentage of between about 5% to 50%, at a gas flow of between about 10 sccm to 200 sccm, at a temperature of between about 350° C. to 700° C. for between 25 seconds to 35 seconds.

It is an object of the invention to synthesize a stable SCO spin-on precursor which can be used for the fabrication of p-type SCO thin films via a spin coating process.

Another object of the invention is to provide p-type conductivity using a low temperature two step annealing process.

A further object of the invention is to provide SCO thin films which are integratable with n-type ZnO thin films.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the method of the invention.

FIG. 2 is a XRD of a SCO thin film fabricated according to the method of the invention.

### DETAILED DESCRIPTION OF THE PREFERRED EMBODIMENTS

Known light emitting diodes employ materials that are quite incompatible with conventional silicon technology. The III-V class of materials, such as GaAs, InP, etc., are not easily integratable into a silicon based device fabrication protocols. This invention provides a synthesis procedure using an organic solvent-based SrCu₂O₂ (SCO) precursor solution, which may be used for the deposition of SCO thin films via spin-coating techniques, which incorporate a low temperature post-annealing process, for the preparation of p-type SCO thin films on silicon-based devices.

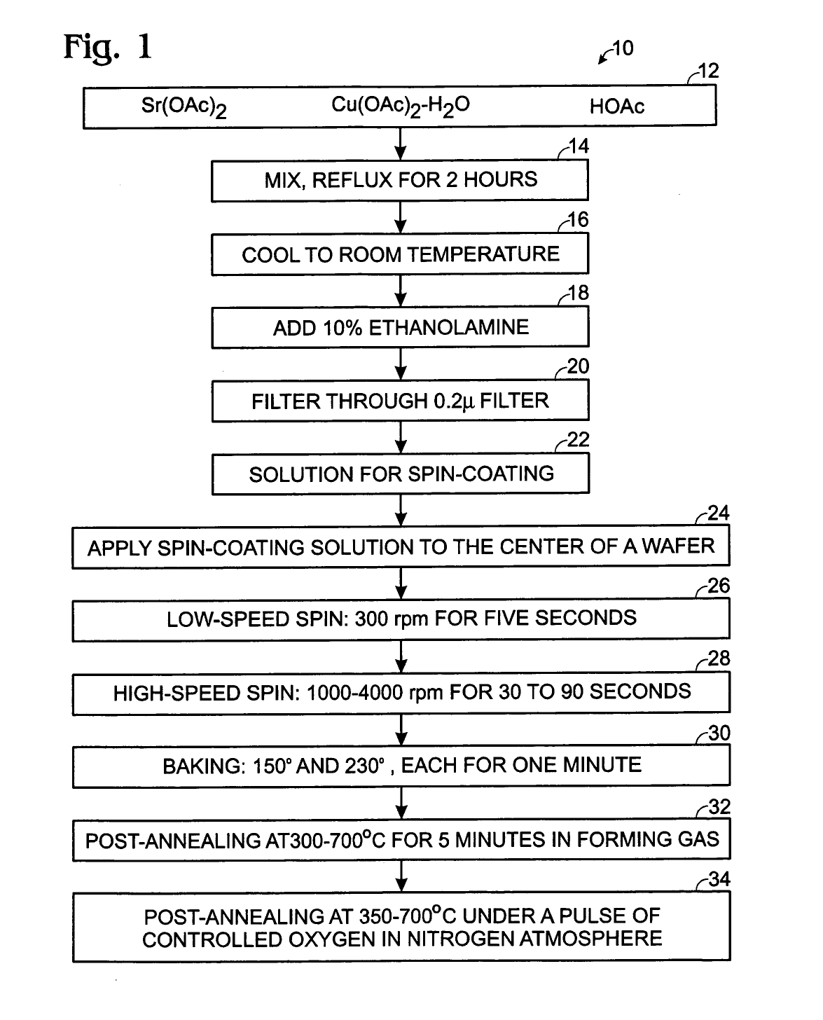

Referring now to FIG. 1, wherein the method of the invention is depicted generally at 10, metalorganic compounds are used as the starting chemicals, which compounds are strontium acetate (Sr(OAc)₂), wherein acetate (CH₃CO₂) is represented by “OAc”, copper(II) acetate monohydrate (Cu(OAc)₂.H₂O), and acetic acid (HOAc) as the solvent, 12, with Sr in a 0.5M concentration. After mixing and refluxing for about two hours, 14, the solution is cooled to room temperature, 16, and 10% ethanolamine is added, 18. Strong stirring is applied during the addition of ethanolamine, because there is a strong reaction between the acid solution and the base of ethanolamine. The purpose of the addition of ethanolamine is to obtain a stable precursor solution which does not precipitate metal organic crystals during storage. The solution viscosity is increased after the addition of the ethanolamine. The mixture is filtered, 20, resulting in the spin-coating precursor, 22.

Once the precursor is prepared, the solution is spin-coated, 24. A silicon wafer having a layer of ZnO, formed by state-of-the-art processes, is prepared. The spin-coating precursor solution is initially spread on a ZnO wafer surface uniformly at a slow spin speed, e.g., about 300 RPM for about five seconds, 26; and then formed into a thin film via a faster spin which uniformly spreads the precursor solution over the wafer, e.g., between about 1000 RPM and 4000 RPM for between about 30 seconds to 90 seconds, 28. The freshly coated thin film is baked in a two step hot-plate bake 30 in air to evaporate most of the solvents. The first bake step is at about 150° C. for about one minutes, and the second bake step is at about 230° C. for about one minute.

A two-step post-anneal process is used to obtain a Cu(I)₂O phase. In the first step, 32, the film is annealed in forming gas in a temperature range of between about 300° C. to 700° C. for about five minutes in forming gas, from which the thin film showed only metal Cu peaks. The second anneal step, 34, was performed to oxidize the metal copper to Cu(I)₂O using a controlled oxygen dose mixed with nitrogen atmosphere. The temperature for this step was in a range of between about 350° C. to 700° C. for between 25 seconds to 35 seconds in an oxygen/nitrogen ambient atmosphere, at a gas flow of between about 10 sccm to 200 sccm, with the oxygen percentage being between about 5% to 50%.

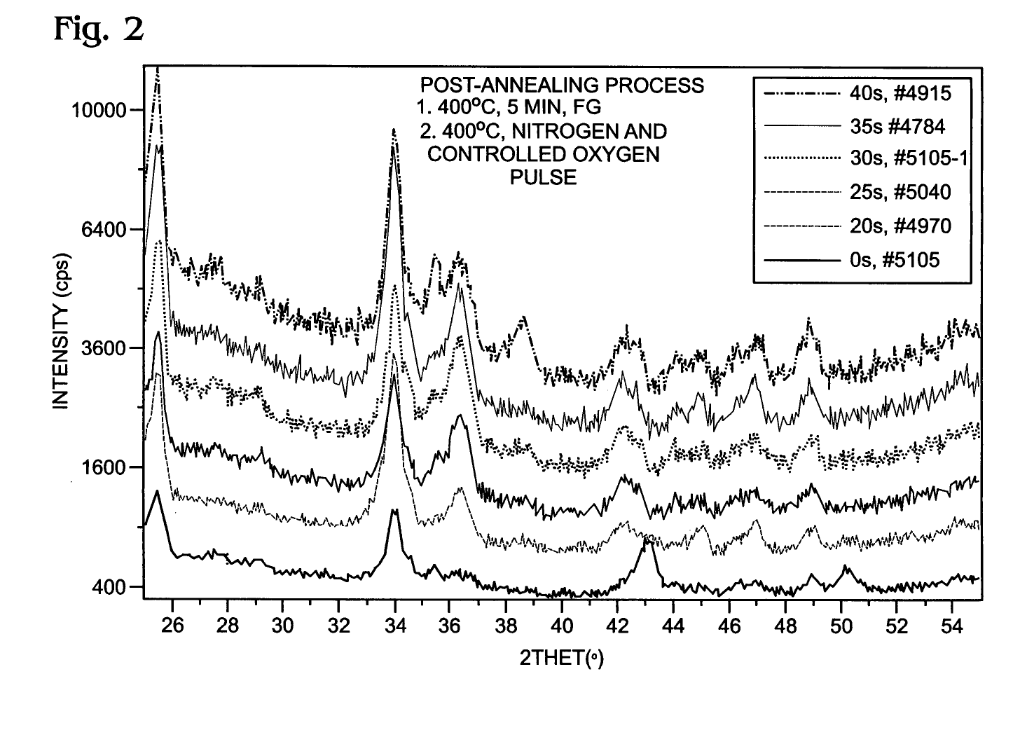

The XRD results are shown in FIG. 2. Without the oxygen pulse in anneal step 34, the spectrum would show only the metal copper phase at 2θ of 43.3 for Cu[111] and 50.4 for Cu[200]. When the oxygen pulse duration was set in the range of between about 20 seconds to 35 seconds, a strong Cu(I)₂O phase was observed at 2θ of 36.5 for Cu₂O[111] and Cu₂O[200]. For longer oxygen pulse durations, e.g., 40 seconds, Cu(II)O was observed at 2θ of CuO[111] at 35.5 and 38.7. The thin film with Cu(I)₂O dominant phase showed p-type conductivity property under Hall measurements. An annealing chamber having optimal control of ambient oxygen concentration for the formation of Cu(I)₂O may simplify the post annealing process into a single annealing step.

Thus, a method of SrCu₂O₂ spin-on precursor synthesis and low temperature p-type thin film deposition has been disclosed. It will be appreciated that further variations and modifications thereof may be within the scope of the invention as defined in the appended claims.

We claim:

1. A method of SrCu₂O₂ spin-on precursor synthesis and low temperature p-type thin film deposition, comprising:
preparing a wafer to receive a spin-coating thereon;
selecting metalorganic compounds to form a SrCu₂O₂ precursor;
mixing and refluxing the selected metalorganic compounds to form a precursor mixture having solvents therein;
adding ethanolamine to the precursor mixture;
filtering the precursor mixture to produce a spin-coating precursor;
applying the spin-coating precursor to the wafer in a two-step spin coating procedure, including:
spin coating the wafer at a first, slow spin speed; and
spreading the spin-coating precursor on the wafer at a second, higher spin speed;
baking the spin-coated wafer using a hot-plate bake to evaporate substantially all of the solvents; and
annealing the spin-coated wafer to form a SrCu₂O₂ layer thereon.

2. The method of claim 1 wherein said selecting metalorganic compounds to form a SrCu₂O₂ precursor includes selecting strontium acetate (Sr(OAc)₂) and copper(II) acetate monohydrate (Cu(OAc)₂.H₂O), and acetic acid (HOAc) as a solvent.

3. The method of claim 1 wherein mixing and refluxing the selected metalorganic compounds includes refluxing the precursor mixture for about two hours; and cooling the precursor mixture to room temperature.

4. The method of claim 1 wherein said spin coating the wafer at a first, slow spin speed includes spin coating the wafer at a first, uniform spin speed of about 300 RPM for about five seconds.

5. The method of claim 1 wherein said spreading the spin-coating precursor on the wafer at a second, higher spin speed includes spreading the spin-coating precursor on the wafer at a speed of between about 1000 RPM and 4000 RPM for between about 30 seconds to 90 seconds.

5. The method of claim 1 wherein said baking the spin-coated wafer using a hot-plate bake to evaporate substantially all of the solvents includes a two-step baking procedure, wherein a first bake step is done at a temperature of about 150° C. for about one minute, and wherein the second bake step is done at a temperature of about 230° C. for about one minute.

6. The method of claim I wherein said annealing the spin-coated wafer to form a SrCu₂O₂ layer thereon is a two-step post-anneal process to obtain a Cu(I)₂O phase, wherein a first annealing step includes annealing the spin-coated wafer in forming gas in a temperature range of between about 300° C. to 700° C. for about five minutes; and wherein a second annealing step includes annealing in a controlled oxygen atmosphere having nitrogen atmosphere, at a gas flow of between about 10 sccm to 200 sccm, at a temperature of between about 350° C. to 700° C. for between 25 seconds to 35 seconds, at an oxygen percentage of between about 5% to 50%.

7. A method of SrCu₂O₂ spin-on precursor synthesis and low temperature p-type thin film deposition, comprising:
preparing a wafer to receive a spin-coating thereon;
mixing and refluxing metalorganic compounds to form a SrCu₂O₂ precursor, including mixing and refluxing strontium acetate (Sr(OAc)₂) and copper(II) acetate monohydrate (Cu(OAc)₂.H₂O), and acetic acid (HOAc) as a solvent, to form a precursor mixture;
adding ethanolamine to the precursor mixture;
filtering the precursor mixture to produce a spin-coating precursor;
applying the spin-coating precursor to the wafer in a two-step spin coating procedure, including:
spin coating the wafer at a first, uniform spin speed of about 300 RPM for about five seconds; and
spreading the spin-coating precursor on the wafer at a second, higher spin speed of between about 1000 RPM and 4000 RPM for about 30 seconds;
baking the spin-coated wafer using a hot-plate bake to evaporate substantially all of the solvent; and
annealing the spin-coated wafer to form a SrCu₂O₂ layer thereon.

8. The method of claim 7 wherein mixing and refluxing the selected metalorganic compounds includes refluxing the precursor mixture for about two hours; and cooling the precursor mixture to room temperature.

9. The method of claim 7 wherein said baking the spin-coated wafer using a hot-plate bake to evaporate substantially all of the solvents includes a two-step baking procedure, wherein a first bake step is done at a temperature of about 150° C. for about one minute, and wherein the second bake step is done at a temperature of about 230° C. for about one minute.

10. The method of claim 7 wherein said annealing the spin-coated wafer to form a SrCu₂O₂ layer thereon is a two-step post-anneal process to obtain a Cu(I)₂O phase, wherein a first annealing step includes annealing the spin-coated wafer in forming gas in a temperature range of between about 300° C. to 700° C. for about five minutes; and wherein a second annealing step includes annealing in a controlled oxygen/nitrogen atmosphere, at a gas flow of between about 10 sccm to 200 sccm, at a temperature of between about 350° C. to 700° C. for between 25 seconds to 35 seconds at an oxygen percentage of between about 5% to 50%.

11. A method of SrCu₂O₂ spin-on precursor synthesis and low temperature p-type thin film deposition, comprising:
preparing a wafer to receive a spin-coating thereon;
selecting metalorganic compounds to form a SrCu₂O₂ precursor, including selecting strontium acetate (Sr(OAc)₂) and copper(II) acetate monohydrate (Cu(OAc)₂.H₂O), and acetic acid (HOAc) as a solvent, to form a precursor mixture;
mixing and refluxing the selected metalorganic compounds to form a precursor mixture;
adding ethanolamine to the precursor mixture;
filtering the precursor mixture to produce a spin-coating precursor;
applying the spin-coating precursor to the wafer in a two-step spin coating procedure, including:
spin coating the wafer at a first, slow spin speed; and
spreading the spin-coating precursor on the wafer at a second, higher spin speed;
baking the spin-coated wafer using a hot-plate bake to evaporate substantially all of the solvents; and
annealing the spin-coated wafer to form a SrCu₂O₂ layer thereon in a two-step post-anneal process to obtain a Cu(I)₂O phase, wherein a first annealing step includes annealing the spin-coated wafer in forming gas in a temperature range of between about 300° C. to 700° C. for about five minutes; and wherein a second annealing step includes annealing in a controlled oxygen/nitrogen atmosphere, at a gas flow of between about 10 sccm to 200 sccm, at a temperature of between about 350° C. to 700° C. for between 25 seconds to 35 seconds at an oxygen percentage of between about 5% to 50%.

12. The method of claim 11 wherein mixing and refluxing the selected metalorganic compounds includes refluxing the precursor mixture for about two hours; and cooling the precursor mixture to room temperature.

13. The method of claim 11 wherein said spin coating the wafer at a first, slow spin speed includes spin coating the wafer at a first, uniform spin speed of about 300 RPM for about five seconds.

14. The method of claim 11 wherein said spreading the spin-coating precursor on the wafer at a second, higher spin speed includes spreading the spin-coating precursor on the wafer at a speed of between about 1000 RPM and 4000 RPM for about 30 seconds.

15. The method of claim 11 wherein said baking the spin-coated wafer using a hot-plate bake to evaporate substantially all of the solvents includes a two-step baking procedure, wherein a first bake step is done at a temperature of about 150° C. for about one minute, and wherein the second bake step is done at a temperature of about 230° C. for about one minute.
